(19) United States
(12) Patent Application Publication
(10) Pub. No.: US 2009/0110377 A1
(43) Pub. Date: Apr. 30, 2009

(54) VIDEO REPRODUCTION DEVICE AND METHOD FOR VIDEO REPRODUCTION

(75) Inventors: Yasushi UNOKI, Yokohama-shi (JP); Satoshi Akimoto, Machida-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/247,697

(22) Filed: Oct. 8, 2008

(30) Foreign Application Priority Data
Oct. 29, 2007 (JP) 2007-280766

(51) Int. Cl. H04N 5/91; H04N 7/01

(52) U.S. Cl. 386/131; 348/448; 348/E07.003

(57) ABSTRACT

According to one embodiment, the invention provides a video reproduction device including a conversion module which is controlled to be selectively switched among a normal reproduction state in which an interlaced video signal is converted into a progressive video signal, an image quality priority reproduction state in which the interlaced video signal is converted into a progressive video signal of a higher quality than that in the normal reproduction state, and a motion priority reproduction state in which the interlaced video signal is output without being converted into a progressive video signal, and a control module which switches each state of the conversion module, in response to the reproduction speed of the reproduced interlaced video signal.

### CROSS-REFERENCE TO RELATED APPLICATIONS

This application is based upon and claims the benefit of priority from Japanese Patent Application No. 2007-280766, filed Oct. 29, 2007, the entire contents of which are incorporated herein by reference.

### BACKGROUND

1. Field

One embodiment of the invention relates to a video reproduction device, which converts an interlaced video signal into a progressive video signal, and a method for video reproduction, and particularly relates to the improvement of a video reproduction device of a variable reproduction speed.

2. Description of the Related Art

As is well known, switchover to digital television broadcasting has recently gained momentum. For instance, in Japan, not only digital direct broadcasting by satellite (DBS) but also terrestrial digital broadcasting have begun.

A digital broadcast receiving apparatus which receives digital television broadcasts incorporates a large-capacity digital recording device such as a hard disk drive (HDD), whereby a received program can be digitally recorded on the hard disk, and, at the same time, a program recorded on the hard disk can be reproduced.

This type of digital broadcast receiving apparatus tends to have an interlaced-to-progressive (IP) conversion function. In other words, an interlaced video signal which is recorded on a recording medium in a digital recording device is converted into a progressive video signal to be output to a video display device, whereby a display video image of high definition is realized.

The digital broadcast receiving apparatus, which has the above IP conversion function and realizes the improvement of the quality of a display video image, is required to be improved so that the display video image quality is improved even in a special reproduction operation in the digital recording device, such as a slow reproduction and a high-speed reproduction, in addition to a normal reproduction operation in the digital recording device.

Jpn. Pat. Appln. KOKAI Publication No. 2004-304788 discloses that, in the slow reproduction in which video signals of the same field are continuously input, the video image of an intended field and the video images before and after the intended field are designated, whereby, even when a video image is switched, the reproduction can be performed during the motion detection and the interpolation between fields, regardless of the reproduction speed, and thus, a clear slow image can be acquired.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram for showing one example of the invention and for explaining the outline of a digital broadcast receiving apparatus;

FIG. 2 is a block diagram for explaining an example of a decoder module of the digital broadcast receiving apparatus in the same example;

FIG. 3 is a view for explaining various states of an IP conversion processing module in the decoder module of the digital broadcast receiving apparatus in the same example;

FIG. 4 is a view for explaining the correspondence relationship between the reproduction speed of HDD and each state of the IP conversion processing module in the digital broadcast receiving apparatus in the same example;

FIG. 5 is a flowchart for explaining a control operation in the IP conversion processing module of the digital broadcast receiving apparatus in the same example;

FIG. 6 is a flowchart for explaining the detail of the control operation in the IP conversion processing module of the digital broadcast receiving apparatus in the same example; and

FIG. 7 is a flowchart for explaining the detail of the control operation in the IP conversion processing module of the digital broadcast receiving apparatus in the same example.

### DETAILED DESCRIPTION

Various embodiments according to the invention will be described hereinafter with reference to the accompanying drawings. In general, according to one embodiment of the invention, the invention provides a video reproduction device including: a conversion module which is controlled to be selectively switched among a normal reproduction state in which an interlaced video signal is converted into a progressive video signal, an image quality priority reproduction state in which the interlaced video signal is converted into a progressive video signal of a higher quality than that in the normal reproduction state, and a motion priority reproduction state in which the interlaced video signal is output without being converted into a progressive video signal; and a control module which switches each state of the conversion module, in response to the reproduction speed of the reproduced interlaced video signal.

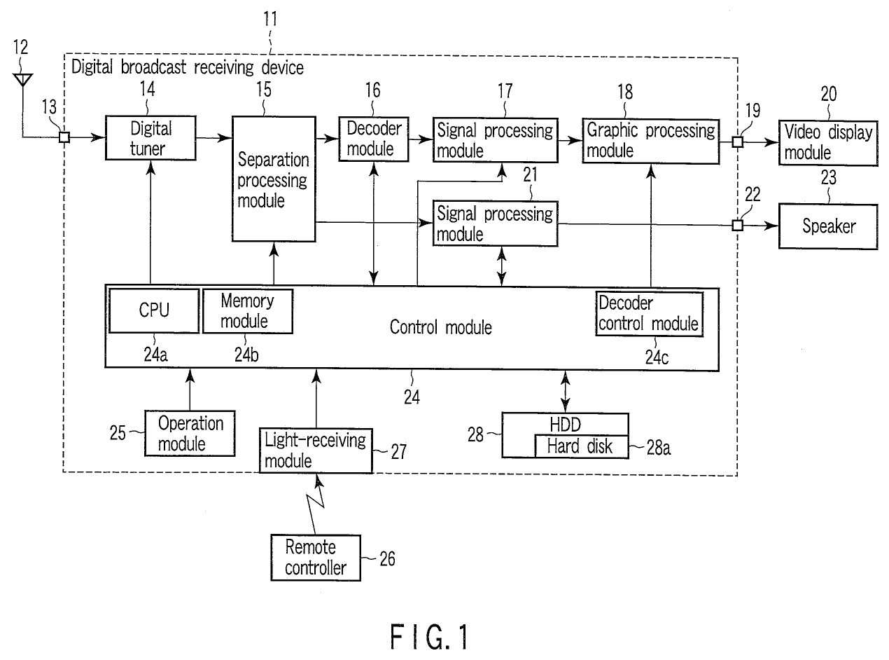

Hereinafter, an example of the invention will be described in detail with reference to the drawings. FIG. 1 shows the outline of a digital broadcast receiving apparatus 11 to be explained in this example. A digital broadcast signal received by an antenna 12 is supplied to a digital tuner 14 through an input terminal 13, whereby the broadcast signal of an intended channel is selected. The broadcast signal selected by the tuner 14 is supplied to a separation processing module 15 to be separated into a video signal and an audio signal.

The video signal is supplied to a decoder module 16 to be subjected to a decode process to be described later, and thereafter to be supplied to a signal processing module 17, whereby predetermined digital signal processing is applied to the video signal. The video signal output from the signal processing module 17 is supplied to a graphic processing module 18, and thus, a predetermined OSD (on screen display) signal is superimposed on the video data, and thereafter, the video data is supplied to a video display module 20 through a video output terminal 19 to be displayed in the video display module 20.

The audio signal acquired by the separation in the separation processing module 15 is supplied to a signal processing module 21 to be subjected to predetermined digital signal processing. The audio signal output from the signal processing module 21 is supplied to a speaker 23 through an audio output terminal 22 to be audibly reproduced.

Here, a control module 24 controls the overall operation of the digital broadcast receiving apparatus 11 including the above receiving operation. The control module 24 has a built-in central processing unit (CPU) 24a and receives operation information, which is acquired from an operation module 25 provided in the main body of the digital broadcast receiving apparatus 11 or operation information transmitted from a remote controller 26 and received by a light-receiving module 27, to control each modules so that the operation contents are reflected.

In that case, the control module 24 mainly utilizes a memory module 24b. The memory module 24b has a read-only memory (ROM) in which a control program executed by the CPU 24a is stored, a random access memory (RAM) providing a work area for the CPU 24a, and a nonvolatile memory in which various pieces of setting information, various pieces of control information, and the like are stored.

Meanwhile, an HDD 28 is connected to the control module 24. On the basis of the operation of the operation module 25 or the remote controller 26 performed by a user, the control module 24 can control the HDD 28 so that the video signal acquired from the decoder module 16 and the audio signal acquired from the signal processing module 21 are supplied to the HDD 28 to be recorded on a hard disk 28a.

Further, on the basis of the operation of the operation module 25 or the remote controller 26 performed by a user, the control module 24 can control so that the video signal and the audio signal are read from the hard disk 28a by the HDD 28 to be respectively supplied to the decoder module 16 and the signal processing module 21, and, thus, to be respectively reproduced.

Further, the control module 24 has a decoder control module 24c. When the video signal recorded on the hard disk 28a is reproduced by the HDD 28, the decoder control module 24c is operated to adaptively control the behavior of an IP conversion processing module 16 within the decoder module 16, in response to the reproduction speed set by a user.

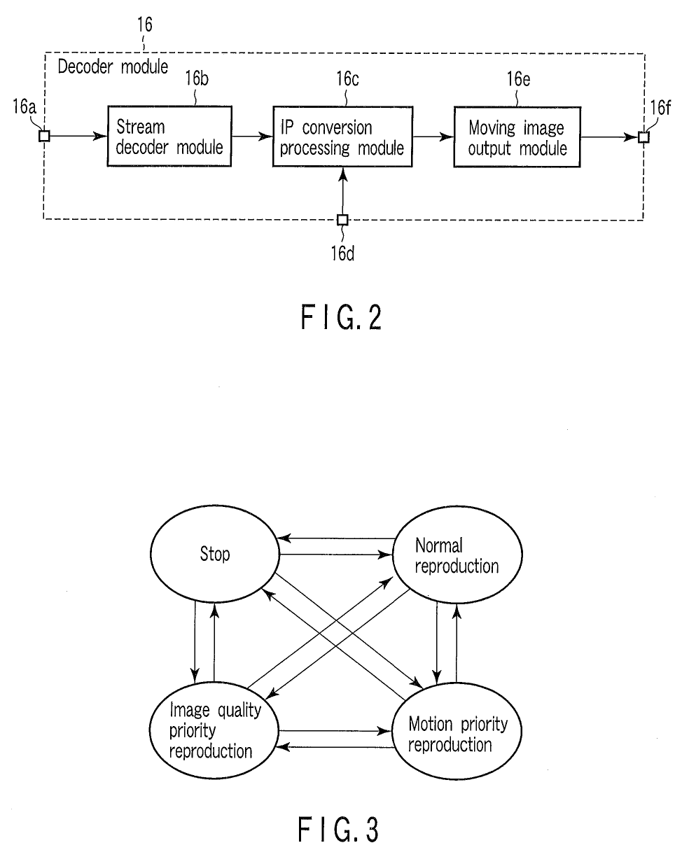

FIG. 2 shows an example of the decoder module 16. The video signal acquired by the separation in the separation processing module 15 or the video signal read from the hard disk 28a is supplied to a stream decoder module 16b through an input terminal 16a. The stream decoder module 16b applies a decoding process to the input video signal to generate an uncompressed video signal, and, thus, to output the video signal to the IP conversion processing module 16c.

The IP conversion processing module 16c converts an input interlaced video signal into a progressive video signal. For example when an interlaced video signal of 60 fields (30 frames) per second is input, the IP conversion processing module 16c is operated to convert the input video signal into a progressive video signal of 60 fields per second.

In general, in the IP conversion, scanning lines thinned out by an interlace method are interpolated based on the neighboring scanning lines. In this example, a motion-compensation method in which the interpolation contents are switched in response to the motion of a video image is used as a method for interpolating scanning lines. As an example of the motion-compensation method, there is a method for calculating a motion vector of one pixel between the fields before and after the field frame, which is a target to be subjected to the IP conversion, to calculate the interpolation contents.

When the video signal recorded on the hard disk 28a is reproduced, a control signal, which is output from the decoder control module 24c, in response to the reproduction speed set by a user, is supplied to the IP conversion processing module 16c through a control terminal 16d, whereby the behavior of the IP conversion processing module 16c is controlled.

The video signal output from the IP conversion processing module 16c is supplied to a moving image output module 16e to be subjected to predetermined moving image processing, and thereafter to be supplied to the signal processing module 17 through an output terminal 16f.

Next, the adaptive control of the behavior of the IP conversion processing module 16c in response to the reproduction speed of a video signal from the hard disk 28a is described. The IP conversion processing module 16c, as shown in FIG. 3, can be selectively switched to four states of a stop state, a normal reproduction state, an image quality priority reproduction state, and a motion priority reproduction state. The IP conversion processing module 16c can be shifted from the current state to any other states.

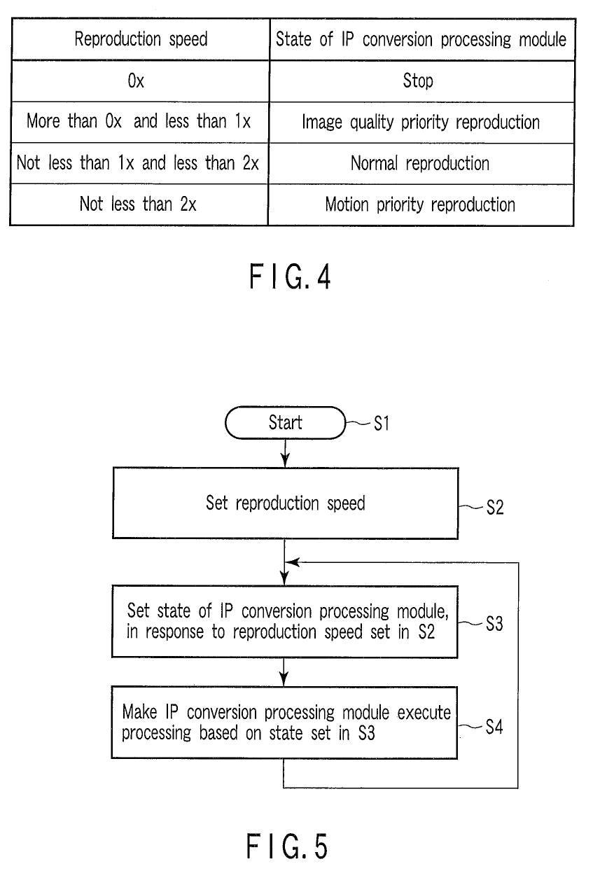

FIG. 4 shows the correspondence relationship between the reproduction speed for reproducing a video signal from the hard disk 28a and the state of the IP conversion processing 16c. In this case, when a user sets the reproduction speed, a control signal corresponding to the reproduction speed is output from the decoder control module 24c, and, thus, to be supplied to the IP conversion processing 16c through the control terminal 16d, whereby the IP conversion processing 16c is set to be in a state corresponding to the reproduction speed.

When the reproduction speed is 0× a normal reproduction speed, that is, when a video signal from the hard disk 28a is not reproduced, the IP conversion processing 16c is in the stop state. Meanwhile, when the reproduction speed is more than 0× and less than 1× the normal reproduction speed, that is, in the slow reproduction in which the reproduction speed is slower than that in the normal reproduction, the IP conversion processing 16c is in the image quality priority reproduction state. When the reproduction speed is not less than 1× and less than 2× the normal reproduction speed, the IP conversion processing 16c is in the normal reproduction state. When the reproduction speed is not less than 2× the normal reproduction speed, the IP conversion processing 16c is in the motion priority reproduction state.

Here, each state of the IP conversion processing 16c is described. First, the stop state represents a state in which the IP conversion processing is not executed. In the normal reproduction state, the IP conversion processing is applied to all the input field format video signals, and the video signals are output as a progressive video signal.

In the image quality priority reproduction state, the IP conversion processing applied to an input field format video signal is performed so that a search range for each pixel in a motion-compensation process is widened. This IP conversion processing can be realized by setting various parameters, set in the IP conversion processing module 16c, to a value different from the value in the normal reproduction state. The search range is widened in the motion-compensation process, whereby although the processing amount in each input field format video signal is increased, the processing can be expected to be performed with time to spare due to the slow reproduction, and, at the same time, the improvement of the image quality of each progressive frame which is output as the IP conversion result can be expected.

In the motion priority reproduction state, the input field format video signal is output as a field format video signal without being subjected to the IP conversion processing. This is because in order to give priority to the motion, that is, the temporal smoothness of the output video image, rather than a case in which the IP conversion processing is applied to each field format video signal to improve the image quality of a progressive frame, the outputting of temporally continuous field format video signals can realize a smoother display video image.

According to the above constitution, when the reproduction speed is 0× the normal reproduction speed, that is, in the stop state in which the reproduction of the video signal from the hard disk 28a is not performed, the IP conversion processing module 16c is in the stop state. Meanwhile, when a user requires the high-speed reproduction in which a video image is displayed at a higher reproduction speed than that in the normal reproduction, a value in which the reproduction speed is not less than 1× the normal reproduction speed is set to the decoder control module 24c. At this time, the following control signal is supplied from the decoder control module 24c to the IP conversion processing module 16c.

First, when the reproduction speed is not less than 1× and less than 2× the normal reproduction speed, the decoder control module 24c generates a control signal used for directing the IP conversion processing module 16c to operate in the normal reproduction state. The IP conversion processing module 16c then applies the IP conversion processing to the entire input field format video signals and operates so as to output a progressive video signal. In this case, the moving image output module 16e to which the progressive video signals output from the IP conversion processing module 16c are input executes a process for thinning the input frame video signals according to the output timing to the video display module 20.

Meanwhile, when the reproduction speed is 2× the normal reproduction speed, the decoder control module 24c generates a control signal used for directing the IP conversion processing module 16c to operate in the motion priority reproduction state. The IP conversion processing module 16c then operates to output the video signals of an interlaced format without applying the IP conversion processing to all the input field format video signals. In this case, the moving image output module 16e to which the interlaced video signals output from the IP conversion processing module 16c are input executes a process for thinning the input video signals according to the output timing to the video display module 20.

Meanwhile, when a user requests the slow reproduction in which a video image is displayed at a reproduction speed slower than that in the normal reproduction, a value in which the reproduction speed is more than 0× and less than 1× the normal reproduction speed is set to the decoder control module 24c. In the slow reproduction, the time required for displaying each frame is increased, and therefore, the image quality of each frame is required to be improved. When the reproduction speed is more than 0× and less than 1× the normal reproduction speed, the decoder control module 24c generates a control signal used for directing the IP conversion processing module 16c to operate in the image quality priority reproduction state.

According to this, the IP conversion processing module 16c in the image quality priority reproduction state increases the search range used for the motion-compensation processing. For example when the search range is ±4 pixels in the normal reproduction state, the search range is ±8 pixels in the image quality priority reproduction state. In such an image quality priority reproduction state, when a field format video signal is input to the IP conversion processing module 16c, the pixel search range used for calculating the motion vector is increased, and therefore, although the processing amount of the IP conversion processing in each field format video signal is increased, more appropriate interpolation information is selected by the increasing of the image search range, whereby the image quality of a progressive video signal output after the interpolation can be improved.

According to the above example, the behavior of the IP conversion processing module 16c is adaptively changed in response to the reproduction speed, and the IP conversion is not performed in the high-speed reproduction giving priority to a motion, and therefore, the processing required for each input frame is reduced to increase the number of frames to be processed, whereby the display with smooth motion can be realized. In the slow reproduction giving priority to the image quality of each frame over the smooth movement, the processing required for each frame is increased, whereby the image quality can be improved. In other words, rather than the normal reproduction, the image quality can be improved in the low-speed and high-speed reproduction operation.

FIG. 5 is a flowchart showing a processing operation of adaptively controlling the behavior of the IP conversion processing module 16c, in response to the reproduction speed. The processing is started (step S1), and when a user sets the reproduction speed in step S2, the decoder control module 24c sets the state of the IP conversion processing module 16c on the basis of the correspondence relationship shown in FIG. 4, in response to the reproduction speed set by the user in step S3. Thereafter, the decoder control module 24c supplies a control signal, which corresponds to the state set in step S3, to the IP conversion processing module 16c, whereby the IP conversion processing module 16c performs processing based on the state in step S4. The processing operation is then returned to step S3.

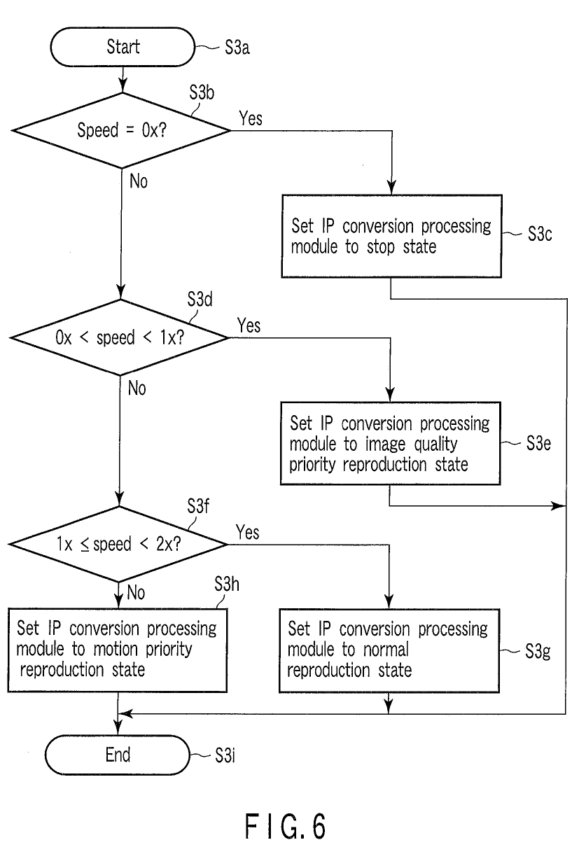

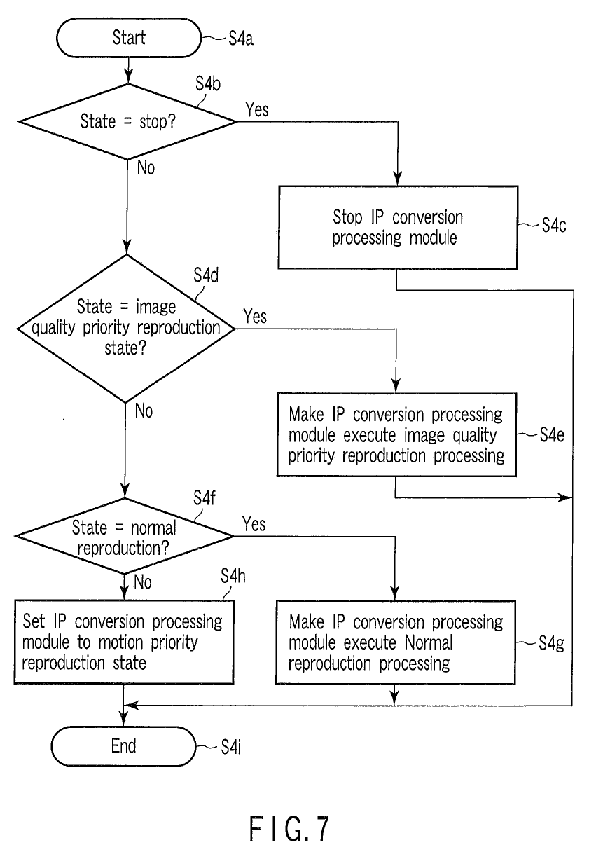

FIG. 6 shows a specific example of the processing in step S3. When the processing is started (step S3a), the decoder control module 24c determines whether or not the reproduction speed set by the user is 0× the reproduction speed in step S3b. When the reproduction speed is 0× the reproduction speed (Yes in step S3b), the IP conversion processing module 16c is set to be in the stop state in step S3c, and the processing is terminated (step S3i).

When the reproduction speed set is not 0× the reproduction speed (No in step S3b), the decoder control module 24c determines whether or not the reproduction speed set by the user is 0×<reproduction speed<1×normal reproduction speed in step S3d. When the reproduction speed is 0×<reproduction speed<1×normal reproduction speed step (S3d is “Yes”), the IP conversion processing module 16c is set to be in the image quality priority reproduction state in step S3e, and the processing is terminated (step S3i).

When the reproduction speed set by the user is not 0×<reproduction speed<1×normal reproduction speed (No in step S3d), the decoder control module 24c determines whether or not the reproduction speed set by the user is 1×≦reproduction speed<2×normal reproduction speed in step S3f. When the reproduction speed is 1×≦reproduction speed<2×normal reproduction speed step (S3f is “Yes”), the IP conversion processing module 16c is set to be in the normal reproduction state in step S3g, and the processing is terminated (step S3i).

When the reproduction speed set by the user is not 1×≦reproduction speed<2×normal reproduction speed (No in step S3f), the decoder control module 24c sets the IP conversion processing module 16c in the motion priority reproduction state in step S3h to terminate the processing (step S3i).

FIG. 7 shows a specific example of the processing in step S4. When the processing is started (step S4a), the decoder control module 24c determines whether or not the IP conversion processing module 16c is set to be in the stop state in step S4b. When the IP conversion processing module 16c is in the stop state (Yes in step S4b), a control signal corresponding to the stop state is supplied to the IP conversion processing module 16c to stop the IP conversion processing module 16c in step S4c, whereby the processing (step S4i) is terminated.

When the IP conversion processing module 16c is not set to be in the stop state (No in step S4b), the decoder control module 24c determines whether or not the IP conversion processing module 16c is set to be in the image quality priority reproduction state in step S4d. When the IP conversion processing module 16c is in the image quality priority reproduction state (Yes in step S4d), the decoder control module 24c supplies a control signal corresponding to the image quality priority reproduction state to the IP conversion processing module 16c to make the IP conversion processing module 16c execute the image quality priority reproduction processing in step S4e, whereby the processing is terminated (step S4i).

When the IP conversion processing module 16c is not set to be in the image quality priority reproduction state (No in step S4d), the decoder control module 24c determines whether or not the IP conversion processing module 16c is set to be in the normal reproduction state in step S4f. When the IP conversion processing module 16c is in the normal reproduction state (Yes in step S4f), the decoder control module 24c supplies a control signal corresponding to the normal reproduction state to the IP conversion processing module 16c to make the IP conversion processing module 16c execute the normal reproduction processing in step S4g, whereby the processing is terminated (step S4i).

When the IP conversion processing module 16c is not set to be in the normal reproduction state (No in step S4f), the decoder control module 24c supplies a control signal corresponding to the motion priority reproduction state to the IP conversion processing module 16c to make the IP conversion processing module 16c execute the motion priority reproduction processing in step S4h, whereby the processing is terminated (step S4i).

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video reproduction device comprising:
a reproduction module configured to reproduce an interlaced video signal and have a variable reproduction speed;
a conversion module configured to be controlled to be selectively switched among a normal reproduction state in which the interlaced video signal reproduced in the reproduction module is converted into a progressive video signal, an image quality priority reproduction state in which the interlaced video signal reproduced in the reproduction module is converted into a progressive video signal of a higher quality than that in the normal reproduction state, and a motion priority reproduction state in which the interlaced video signal reproduced in the reproduction module is output without being converted into a progressive video signal; and
a control module configured to selectively switch each state of the conversion module, in response to the reproduction speed of the interlaced video signal reproduced in the reproduction module.

2. A video reproduction device according to claim 1, wherein the control module controls to switch the conversion module to the normal reproduction state when the reproduction speed of the interlaced video signal reproduced in the reproduction module is between a normal reproduction speed and a speed faster than the normal reproduction speed by a previously set predetermined speed, controls to switch the conversion module to the image quality priority reproduction state when the reproduction speed of the interlaced video signal reproduced in the reproduction module is slower than the normal reproduction speed, and controls to switch the conversion module to the motion priority reproduction state when the reproduction speed of the interlaced video signal reproduced in the reproduction module is faster than the normal reproduction speed by the predetermined speed.

3. A video reproduction device according to claim 1, wherein the control module controls to switch the conversion module to the image quality priority reproduction state when the reproduction speed of the interlaced video signal reproduced in the reproduction module is more than 0× and less than 1× the normal reproduction speed, controls to switch the conversion module to the normal reproduction state when the reproduction speed of the interlaced video signal reproduced in the reproduction module is not less than 1× and less than 2× the normal reproduction speed, and controls to switch the conversion module to the motion priority reproduction state when the reproduction speed of the interlaced video signal reproduced in the reproduction module is not less than 2× the normal reproduction speed.

4. A video reproduction device according to claim 1, wherein, when the conversion module is switched to the image quality priority reproduction state, the conversion module renders a pixel search range, used for a motion compensation processing, larger than the pixel search range in the normal reproduction state, whereby the conversion module converts the interlaced video signal reproduced in the reproduction module into a progressive video signal of a higher image quality than the normal reproduction state.

5. A video reproduction device according to claim 1, wherein the conversion module includes a stop state, and the control module switches the conversion module to the stop state when a video signal is not output from the reproduction module.

6. A method for video reproduction comprising:
reproducing an interlaced video signal with a reproduction module of a variable reproduction speed;
supplying the interlaced video signal reproduced in the reproduction module to a conversion module which can be selectively switched among a normal reproduction state in which an input interlaced video signal is converted into a progressive video signal, an image quality priority reproduction state in which the input interlaced video signal is converted into a progressive video signal of a higher quality than the normal reproduction state, and a motion priority reproduction state in which the input interlaced video signal is output without being converted into a progressive video signal; and
selectively switching each state of the conversion module, in response to the reproduction speed of the reproduced interlaced video signal.

7. A method for video reproduction according to claim 6, wherein in the switching step, the conversion module is controlled to be switched to the normal reproduction state when the reproduction speed of the interlaced video signal reproduced in the reproduction module is between a normal reproduction speed and a speed faster than the normal reproduction speed by a previously set predetermined speed, the conversion module is controlled to be switched to the image quality priority reproduction state when the reproduction speed of the interlaced video signal reproduced in the reproduction module is slower than the normal reproduction speed, and the conversion module is controlled to be switched to the motion priority reproduction state when the reproduction speed of the interlaced video signal reproduced in the reproduction module is faster than the speed which is faster than the normal reproduction speed by the predetermined speed.

8. A method for video reproduction according to claim 6, wherein in the switching step, the conversion module is controlled to be switched to the image quality priority reproduction state when the reproduction speed of the interlaced video signal reproduced in the reproduction module is more than 0× and less than 1× the normal reproduction speed, the conversion module is controlled to be switched to the normal reproduction state when the reproduction speed of the interlaced video signal reproduced in the reproduction module is not less than 1× and less than 2× the normal reproduction speed, and the conversion module is controlled to be switched to the motion priority reproduction state when the reproduction speed of the interlaced video signal reproduced in the reproduction module is not less than 2× the normal reproduction speed.
